(19) United States
(12) Patent Application Publication
(10) Pub. No.: US 2011/0198777 A1
(43) Pub. Date: Aug. 18, 2011

(54) METHOD FOR MANUFACTURING SEAMLESS THIN-WALLED ARTICLES WITH THERMOPLASTIC MATERIALS

(76) Inventor: Der-Lin LIOU, Taipei City (TW)

(21) Appl. No.: 12/707,483

(22) Filed: Feb. 17, 2010

(51) Int. Cl. B29C 47/26

(52) U.S. Cl. 264/209.2

(57) ABSTRACT

A method for manufacturing seamless thin-walled articles with thermoplastic material is disclosed, wherein the seamless thin-walled articles each having single opening are coated onto plural mold surfaces, which move along a track and respectively have a rotation. The method includes a molten and coating step to coat thermoplastic materials in molten state from at least two extruding mechanisms on the surfaces of the molds; a heating and cooling step to heat the thermoplastic materials by passing the molds, which rotate at the same time, through a heating mechanism to form thin-walled articles with even thickness, and then cool the thermoplastic materials; a lip rolling step to roll up the thermoplastic materials at the lower edge of the opening to form a lip; and a mold releasing step to release the thin-walled articles from the molds.

### FIELD OF THE INVENTION

The present invention is related to a method for manufacturing seamless thin-walled articles with thermoplastic materials, and more particularly to a method for manufacturing seamless thin-walled articles having single opening by thermoplastic materials.

### BACKGROUND OF THE INVENTION

The conventional method for manufacturing elastic thin-walled articles (such as disposable gloves, finger cots, condoms, balloons and the like with single opening at one end) is to dip the mold in a liquid natural or synthetic rubber to form an article. The conventional raw materials are in latex state, such as natural rubber, nitrile butadiene, chloroprene rubber, and polyisoprene rubber, each of which might contain surfactants, chemical impurities and the like. The surfactants and chemical impurities all should be leached out for ensuring the quality of the finished products. But, the leaching process consumes lots of water, manpower and time cost. Besides, the additives, such as sulfur, accelerator, and catalyst, are used in the conventional procedure for enhancing the covalent bonds and improving the physical strength of material (the so-called vulcanization or chemical cross-linking) also might cause allergy to users. Plus, since the chemical cross-linked material is difficult and expensive to recycle.

The thermoplastic elastomer is a recyclable material with rubber characteristics and can be processed by the traditional method used for the plastic, so that as compared with the natural or synthetic rubber, it is more efficient and environmental friendly. Therefore, the thermoplastic elastomer gradually replaces the traditional rubber.

U.S. Pat. Nos. 6,121,366, 6,639,007 and 7,148,283 disclosed methods for manufacturing thin film elastic articles by dipping styrene block copolymer. U.S. Pat. No. 6,720,049 disclosed a method for manufacturing thin film elastic articles by dipping polyurethane. U.S. Pat. Nos. 3,124,807, 4,776,921, 5,833,915, 5,997,676 and 6,243,875 provided methods for forming gloves or other thin film articles by bonding two thin films of polyolefin elastomer or polyurethane elastomer. U.S. Pat. Nos. 4,034,036, 4,358,420, 6,213,123, 6,350,231 and 6,579,582 provided methods for forming thin-walled articles by elongating or applying air pressure to preheated pre-products, thus thin-walled articles, such as the condoms or finger cots, can be formed along tubular molds. U.S. Pat. No. 5,640,720 provided an injection blow molding method for manufacturing elastic synthetic rubber gloves by polyetherester polymer. However, the formed gloves may not have uniform thickness on the opening, hand portion, finger portions and thumb portion, wherein the thickness between the opening and the hand portion and the finger portions and thumb portion is almost as large as four times. Although the finger portions are thinner and provides better tactile feeling, it is also easy to be broken. U.S. Pat. No. 4,921,672 provided an injection blow method for manufacturing electric protection gloves. In this method, only thick films can be formed, so that it is not suitable for disposable gloves.

U.S. Pat. No. 4,687,531 disclosed a method for manufacturing thin-walled articles by spraying thermoplastic material on the inner wall of a mold. But, there has difficulty in manufacturing small-sized thin-walled articles by this method.

U.S. Pat. Nos. 4,434,126, 6,649,116 and 6,890,475 provided powder coating methods for manufacturing thin film articles made of thermoplastic elastomers, since the difference of the particle size may influence the quality of the thin film, for example, the size difference might cause needle or uneven thickness on the thin film. However, ensuring the particle size within a small range is costly. Besides, for grinding, it may need the liquid nitrogen to harden the thermoplastic elastomers, which also cost a lot.

Therefore, it can be understood that as considering the cost of material, the recyclability, human health, high degree automatic production, water and energy consumptions, and the capability of forming three-dimensional shapes, the above-mentioned methods all still have some defects.

### SUMMARY OF THE INVENTION

The object of the present invention is to provide a method for manufacturing an elastic, seamless, three-dimensional thin-walled article having a lip portion at the single opening by continuous and low cost steps.

Another object of the present invention is to replace the traditional rubber material by a material of environment friendly, free of sensitive chemical additives to human body.

The present invention provides a method for manufacturing seamless thin-walled articles with thermoplastic materials, wherein the seamless thin-walled articles each having single opening are coated onto plural mold surfaces, which move along a track and respectively have a rotation. The method includes a molten and coating step to coat thermoplastic materials in molten state from at least two extruding mechanisms on the surfaces of the molds; a heating and cooling step to heat the thermoplastic materials by passing the molds through a heating mechanism, and then cool the thermoplastic materials to form the thin-walled article with even thickness; a lip rolling step to roll up the thermoplastic materials at the lower edges of the openings to form a lip; and a mold releasing step to release the thin-walled articles from the molds.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a flow chart of the present invention;

FIG. 2 is another flow chart of the present invention;

FIG. 3 is a schematic view showing the mechanisms for performing the present invention;

FIG. 4A is a schematic view showing a first embodiment of the thin-walled article;

FIG. 4B is a partial magnifying sectional view of FIG. 4;

FIG. 5 is a schematic view showing a second embodiment of the thin-walled article;

FIG. 6 is a schematic view showing a third embodiment of the thin-walled article; and

FIG. 7 is a schematic view showing a fourth embodiment of the thin-walled article.

### DESCRIPTION OF THE PREFERRED EMBODIMENT

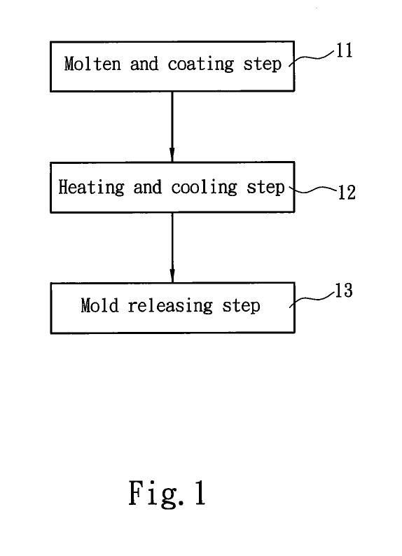

The present invention is related to a method for manufacturing seamless thin-walled articles with thermoplastic materials, wherein the seamless thin-walled articles each having single opening are coated onto plural mold surfaces, which move along a track and respectively have a rotation. Please refer to FIG. 1. The method includes a molten and coating step 11, a heating and cooling step 12 and a mold releasing step 13. In the molten and coating step 11, the thermoplastic material in molten state is extruded from at least two extruding mechanisms to coat at least two layers of thin films on the surface of each mold. In the heating and cooling step 12, the semi-finished products on the molds are heated to the molten state to provide a slight flowing capability, so that by rotating of the molds at the same time, the thermoplastic material can have a more even distribution on the molds, and then the semi-finished products are cooled to solidify the thermoplastic material into films. Thus the thin-walled articles on the molds are finished. Then, in the mold releasing step 13, the thin-walled articles are released from the mold. Finally, the molds without thin-walled articles return to the first step along the track to produce thin-walled articles continuously and automatically.

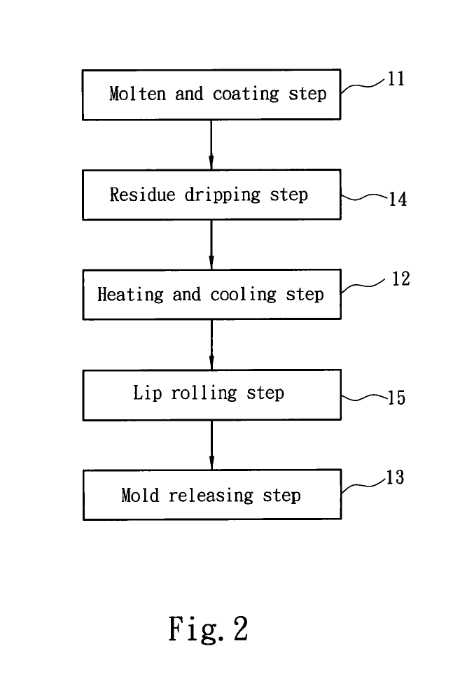

Moreover, other steps also can be provided. As shown in FIG. 2, because there might have excess thermoplastic materials on the molds, a residue dripping steps 14 can be performed prior to the heating and cooling steps 12. In the residue dripping step 14, in addition to moving along the track, the molds also move to a dripping position for dropping out the residual thermoplastic materials. The dripping position can be nearly a vertical position for facilitating the dropping out or can be slight a slant position with a small angle, which additionally benefits the even distribution. The residue dripping step 14 can be performed after the molten and coating step 11 or after coating one of layers of thermoplastic material. After dripping for a sufficient period of time, the molds move into a heating mechanism to start the heating and cooling step 12. Here, the thermoplastic materials on the surfaces of the molds are heated by the heating mechanism to regain the flowing molten state, so that by rotating the molds at the same time, the thickness of the thermoplastic material becomes more even. After leaving the heating mechanism, the thermoplastic materials are cooled to form the thin-walled articles with uniform thickness. Here, the cooling can be exposed at the cooling air condition or by spraying water on the molds to lower the temperature (in which the finished products need to be dried). After the heating and cooling step 12, a lip rolling step 15 can be performed by rolling up the thermoplastic material at the lower edge of the opening so as to provide a lip portion of the thin-walled article.

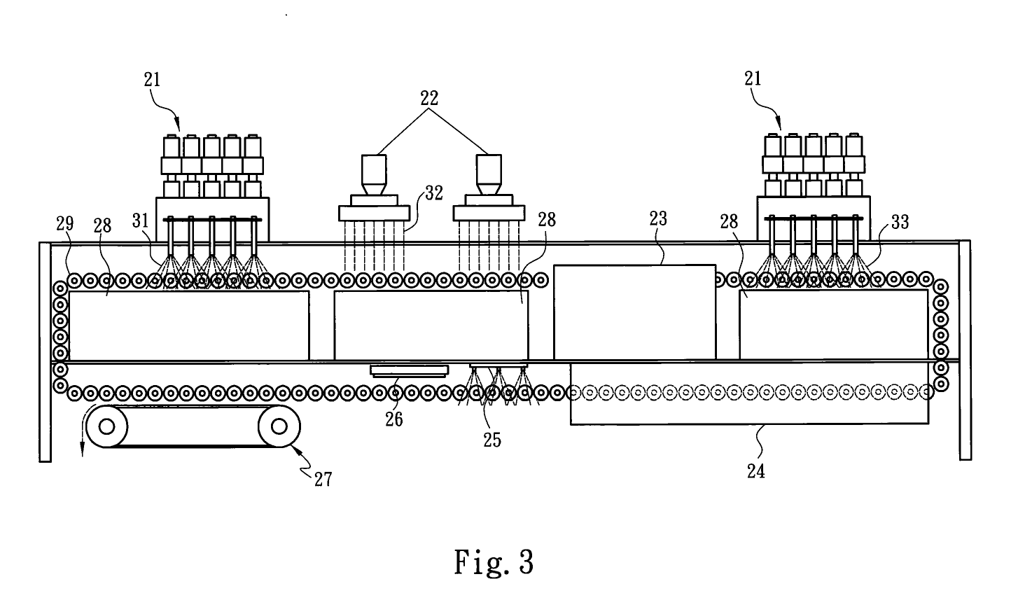

As known, when donning the conventional rubber product, there exists an adhesive resistance on the surface. The thin-walled article formed by the above-described steps can overcome this problem. Because the material coating is performed by at least two extruding mechanisms which produce two layers of thin films, it is possible to provide different tactile feelings and friction for the inner and the outer surfaces of the thin-walled article. For example, the inner surface can be formed to be smoother for facilitating the donning, and the outer surface can be formed to be tougher and higher friction for benefiting the grabbing. Therefore, according to the steps in FIG. 1 and FIG. 2, improved thin-walled articles can be formed, and further, the thermoplastic material is not only harmless to human health, but also recyclable. Please refer to FIG. 3, which is a schematic view of the present invention showing that plural molds 29 pass through each mechanism for performing the above steps. The procedure starts from the upper-left side of this drawing. Plural molds 29 move along a track (not shown in the drawings) by means of a motor or a transportation mechanism, and each mold 29 rotates constantly.

The molten and coating step 11 utilizes at least two extruding mechanisms 21 and 22, which are not limited. For example, the extruding mechanisms 21 can spray the thermoplastic materials as mists, the extruding mechanism 22 can pour the thermoplastic materials as liquid curtains, or a combination of at least two extruding mechanisms 21 and 22 can respectively provide the mist spray and the poured liquid curtain of the thermoplastic materials. Furthermore, the extruding mechanism 22 also can be a co-extruding mechanism to squeeze multiple layers of thermoplastic materials as liquid curtains at the same time. As the procedure starts, the extruding mechanism 21 sprays a first thermoplastic material 31 in molten state on the surfaces of the molds 29 to form a thin film, and then the molds 29 pass through another extruding mechanism 22 which pours a second thermoplastic material 32 as liquid curtain, for coating a layer of the second thermoplastic material 32. Now, there already have two layers of thin films, which are not yet formalized on the molds 29. After passing through the extruding mechanism 22, the residue dripping step 14 can make the thickness of the thermoplastic materials on the molds 29 more even and drop out the residual materials. A dripping region 23 is provided next to the extruding mechanisms 21 and 22 for receiving the dropped thermoplastic materials. In the dripping region 23, in addition to moving along the track, the molds 29 move to a nearly vertical position for dropping out the residual thermoplastic materials or to a slight slant position with a small angle, which additionally benefits more even distribution of the non-formalized and non-uniform thermoplastic materials by cooperating with the rotation of the molds 29. Then, after the residue dripping step 14, the molds 29 pass through another extruding mechanism 21 which sprays a third thermoplastic material 33 for coating with the third thermoplastic material 33 on the surface of the molds 29 and forms three layers of thin films. Then, the molds 29 enter to an oven 24 for heating while the molds 29 still rotate so as to benefit the flowing of the thermoplastic materials and uniform the thickness. After further passing through a water spray 25 and a dryer 26, the heating and cooling step 12 is finished. Now, the thin-walled articles are substantially formalized. And, because of the three-layer structure, the thin-walled articles can have sufficient strength, elasticity and proper surface friction.

Here, the lip rolling step 15 may also be selected to provide the lip portion of the thin-walled article. Finally, the finished thin-walled articles are released from the molds 29 through a mold releasing mechanism 27. As shown, the moving of the molds 29 is circular, so that the molds 29 will continue to perform the first step after the mold releasing step 13 for achieving an automatic, rapid and mass production. Besides, at least a waste recycling mechanism 28 can be further provided to collect the thermoplastic materials which are not coated on the molds 29 as performing the molten and coating step 11, so that the materials can be fully utilized, thereby reducing the meaningless consumption.

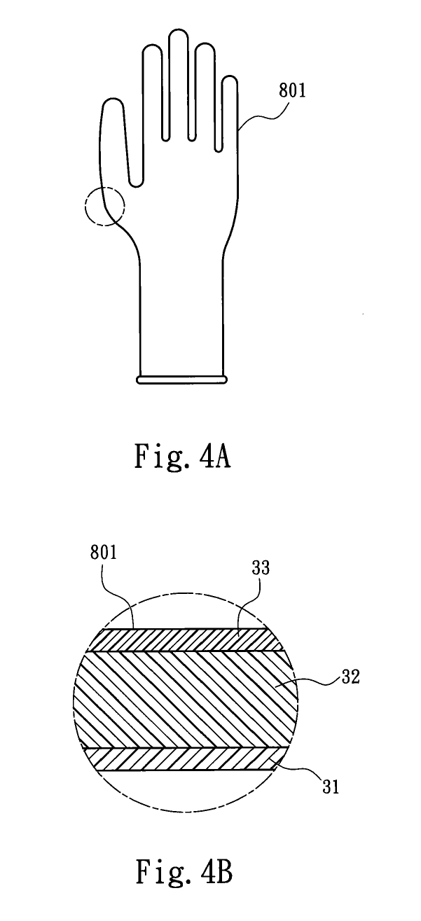

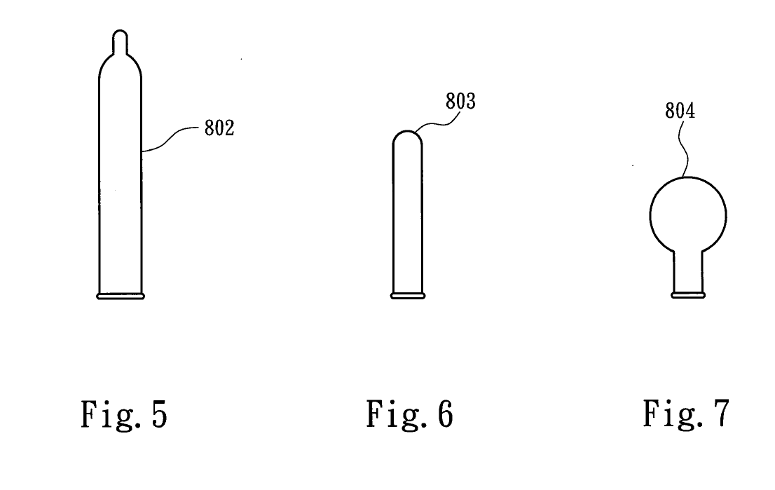

Please refer to FIG. 4A which shows the thin-walled article formed by the above steps and mechanisms. FIG. 4A shows a glove 801. The glove 801 has single opening and a lip portion at the opening. FIG. 4B shows the section of the three-layer structure of thin films. The three thin films are respectively coated the first, the second and the third thermoplastic materials 31, 32 and 33 on the molds 29. The three thermoplastic materials 31, 32 and 33 can have different compositions, for example, to have slight property differences. However, the three materials 31, 32 and 33 include at least 50% of thermoplastic elastomer. The formed thin-walled article can be a glove 801 (as shown in FIG. 4A), a condom 802 (as shown in FIG. 5), a finger cot 803 (as shown in FIG. 6), a balloon 804 (as shown in FIG. 7), a shower cap (not shown in the drawings) or a shoe cover (not shown in the drawings), which is decided by the shape of the mold 29.

The at least 50% of thermoplastic elastomer is contained in the first, the second and the third thermoplastic materials 31, 32 and 33 can be selected from a group consisting of polyamide elastomer, polyurethane elastomer, polystyrene block copolymer and polyolefin elastomer.

The thermoplastic material can further include polyethylene, polypropylene, antioxidant, stabilizer, anti-blocking agent, mold release agent, filler, pigment and the like.

In the aforesaid, the present invention is advantageous that:

1. The water and energy consumption in the producing procedure can be reduced for lowering the cost.

2. The recyclable thermoplastic material is more environment friendly and also allergy free to human body.

3. The finished product is elastic, seamless, three-dimensional and not easy to be broken.

4. The procedure is simplified to provide convenience with the lip portion can be formed in the same procedure.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing seamless thin-walled articles with thermoplastic materials, wherein the seamless thin-walled articles with single opening are coated onto plural mold surfaces, which move along a track and respectively have a rotation, the method comprising the steps of:
a molten and coating step: coating thermoplastic materials in molten state from at least two extruding mechanisms on the surfaces of molds;
a heating and cooling step: heating the thermoplastic materials by passing the molds, which rotate at the same time, through a heating mechanism to form thin-walled articles with even thickness, and then cooling the thermoplastic materials; and
a mold releasing step: releasing the thin-walled articles from the molds.

2. The method as claimed in claim 1, wherein in the molten and coating step, the extruding mechanism is employed to spray the thermoplastic materials as mist.

3. The method as claimed in claim 1, wherein in the molten and coating step, the extruding mechanism is employed to pour the thermoplastic materials as liquid curtains.

4. The method as claimed in claim 1, wherein in the molten and coating step, a combination of at least two extruding mechanisms are employed to respectively spray the thermoplastic materials as mist and to pour the thermoplastic materials as liquid curtains.

5. The method as claimed in claim 1, wherein after the heating and cooling step, a lip rolling step is further included for rolling up the thermoplastic materials at the lower edge of the opening of the thin-walled article to form a lip.

6. The method as claimed in claim 1, wherein before the heating and cooling step, a residue dripping step is further included, and in the residue dripping step, the molds move to a nearly vertical position for dropping out the residual thermoplastic materials.

7. The method as claimed in claim 1, wherein in the molten and coating step, a waste recycling mechanism is further provided to collect the thermoplastic materials which are not coated on the molds.

8. The method as claimed in claim 1, wherein different extruding mechanisms provide thermoplastic materials having different compositions.

9. The method as claimed in claim 1, wherein the thermoplastic materials include at least 50% of thermoplastic elastomer.

10. The method as claimed in claim 9, wherein the thermoplastic elastomer is polystyrene block copolymer or a mixture thereof.

11. The method as claimed in claim 9, wherein the thermoplastic elastomer is polyolefin elastomer or a mixture thereof.

12. The method as claimed in claim 9, wherein the thermoplastic elastomer is polyurethane elastomer or a mixture thereof.

13. The method as claimed in claim 9, wherein the thermoplastic elastomer is polyamide elastomer or a mixture thereof.

14. The method as claimed in claim 9, wherein the thermoplastic materials further include polyethylene, polypropylene, antioxidant, stabilizer, anti-blocking agent, mold release agent, filler or pigment.

15. The method as claimed in claim 1, wherein the thin-walled articles are gloves.

16. The method as claimed in claim 1, wherein the thin-walled articles are finger cots.

17. The method as claimed in claim 1, wherein the thin-walled articles are balloons.

18. The method as claimed in claim 1, wherein the thin-walled articles are condoms.

19. The method as claimed in claim 1, wherein the thin-walled articles are shower caps.

20. The method as claimed in claim 1, wherein the thin-walled articles are shoe covers.
